(19) United States
(12) Patent Application Publication
(10) Pub. No.: US 2024/0290301 A1
(43) Pub. Date: Aug. 29, 2024

(54) Space Efficient Stand-Up Stringed Instrument

(71) Applicant: Evan Mellichampe, Denver, CO (US)

(72) Inventor: Evan Mellichampe, Denver, CO (US)

(21) Appl. No.: 18/586,239

(22) Filed: Feb. 23, 2024

Related U.S. Application Data
(60) Provisional application No. 63/447,833, filed on Feb. 23, 2023.

(51) Int. Cl. G10D 3/095; G10D 1/02; G10D 3/01; G10D 3/04; G10D 3/12; G10D 3/22; G10H 3/18

(52) U.S. Cl. CPC G10D 3/095; G10D 1/02; G10D 3/01; G10D 3/04; G10D 3/12; G10D 3/22; G10H 3/18; G10H 2220/461

(57) ABSTRACT

A space efficient stand-up double bass is discussed herein may be directed to an instrument that provides for a compact size format while still enabling a stringed instrument capable of delivering low-end bass notes. The compact bass includes a narrow body (along a y-axis) as compared to a conventional double-bass. The narrow body provides for a more lightweight double bass that is better suited for transport and travel. Further, the narrow body improves the novel narrow body's ability to amplify the sounds of the double bass because conventional width double causes problematic amplified feedback through an electronic transducer such as a pickup system or microphone. The narrow-bodied double bass does not exhibit this same feedback issue.

### CLAIM OF PRIORITY

This application claims the benefit of U.S. Provisional Application No. 63/447,833 entitled “Space Efficient Stand-Up Double Bass Instrument” filed Feb. 23, 2023, which is incorporated by reference in its entirety herein for all purposes.

### BACKGROUND

A stand-up double bass, also known simply as the bass (in symphony/orchestra settings), is the largest and lowest-pitched bowed (or plucked) string instrument in the modern symphony orchestra. Similar in structure to a cello, the double bass typically includes four, although occasionally five, strings and is typically played by an instrumentalist standing next the instrument while holding the double bass upright by the neck. The double-bass is a standard member of the orchestra's string section, along with violins, viola, and cello, as well as the concert band, and is featured in concertos, solo, and chamber music in Western classical music. The bass is used in a range of other genres, such as jazz, 1950s-style blues and rock and roll, rockabilly, traditional country music, bluegrass, and folk music.

The double-bass is a transposing instrument and is typically notated one octave higher than tuned to avoid excessive ledger lines below the staff. The double bass is the only modern bowed string instrument that is tuned in fourths, rather than fifths, with strings usually tuned to E1, A1, D2 and G2. The double bass is played with a bow (arco), or by plucking the strings (pizzicato), or via a variety of extended techniques. In orchestral repertoire and tango music, both arco and pizzicato styles are employed. In jazz, blues, and rockabilly, pizzicato is the norm. Classical music and jazz use the natural sound produced acoustically by the instrument, as does traditional bluegrass. In funk, blues, reggae, and related genres, the double bass is often amplified.

One particular problem that has presented over the years with the double-bass is its sheer size. A double bass is often as tall as the instrumentalist playing it and rather wide in comparison to its height. Such a large format instrument makes the double-bass difficult to transport efficiently.

### BRIEF DESCRIPTION OF THE DRAWINGS

Embodiments of the subject matter disclosed herein in accordance with the present disclosure will be described with reference to the drawings, in which:

FIG. 1 is anisometric view of a conventional stand-up double bass instrument;

FIG. 2 is a plan view of a space efficient stand-up double bass instrument according to an embodiment of the subject matter disclosed herein;

FIG. 3 is a profile view of a space efficient stand-up double bass instrument according to an embodiment of the subject matter disclosed herein;

FIG. 4 is an isometric view of a space efficient stand-up double bass instrument according to an embodiment of the subject matter disclosed herein;

FIG. 5 is a view of a bridge of the space efficient stand-up double bass instrument of FIG. 2 according to an embodiment of the subject matter disclosed herein;

FIG. 6A/B are views of a scroll of the space efficient stand-up double bass instrument of FIG. 4 according to an embodiment of the subject matter disclosed herein;

FIG. 7 is an isometric view of removable peg box of the space efficient stand-up double bass instrument of FIG. 2 having portions that may be disassembled of the space efficient stand-up double bass instrument of FIG. 2 according to an embodiment of the subject matter disclosed herein;

FIG. 8 includes two plan views of the removable peg box of FIG. 7 of the space efficient stand-up double bass instrument of FIG. 2 according to an embodiment of the subject matter disclosed herein;

FIG. 9 is a plan view of a bridge of the space efficient stand-up double bass instrument of FIG. 2 removed from the instrument according to an embodiment of the subject matter disclosed herein;

FIG. 10 is a plan view of an internal biasing means for a neck adjustment mechanism of the space efficient stand-up double bass instrument of FIG. 2 according to an embodiment of the subject matter disclosed herein;

FIG. 11 is an isometric view of an external actuation means for a neck adjustment mechanism of the space efficient stand-up double bass instrument of FIG. 2 according to an embodiment of the subject matter disclosed herein; and

FIG. 12 is an isometric view of an external actuation means for a string nut adjustment mechanism or a bridge adjustment mechanism of the space efficient stand-up double bass instrument of FIG. 2 according to an embodiment of the subject matter disclosed herein.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. This systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

By way of an overview, a space efficient stand-up double bass is discussed herein may be directed to an instrument that provides for a compact size format while still enabling a stringed instrument capable of delivering low-end bass notes. The compact bass includes a narrow body (along a y-axis) as compared to a conventional double-bass. The narrow body provides for a more lightweight double bass that is better suited for transport and travel. Further, the narrow body improves the novel narrow body's ability to amplify the sounds of the double bass because conventional width double causes problematic amplified feedback through an electronic transducer such as a pickup system or microphone. The narrow-bodied double bass does not exhibit this same feedback issue.

In another embodiment, the bass instrument includes a removable fingerboard with a length of nearly 34 inches. By adding the option to remove the fingerboard during transport, the ability to house everything in a much shorter travel case is achieved. The fingerboard can be attached by either using a series of rare earth magnets or by installing several nested frame connectors.

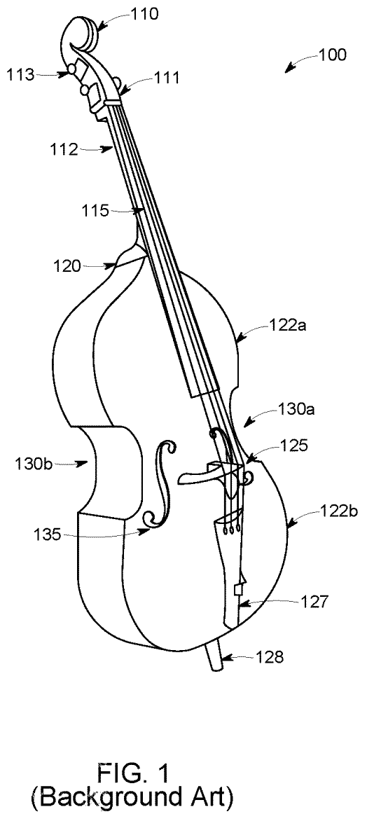

In another embodiment, the bass instrument includes adjustable, removable and interchangeable string nut. This unique string nut is designed to be raised or lowered by turning two Allen bolts. This unique string nut has over 10 times the mass of a normal string nut and rests upon the top of the neck at the base of the head end. It comes in both 4-string and 5-string configurations so as to accommodate either while using the same neck and fingerboard. It also acts to secure the removable fingerboard while assembled and will rest between the two cheeks of the head end. These and other features are better understood through detailed description of FIGS. 1-9 below.

FIG. 1 is an isometric view of a conventional stand-up double bass instrument. In this conventional double-bass instrument 100, one can see that the width and girth of the conventional double-bass is substantial when compared to its height. Thus, a large and robust resonant chamber (e.g., body 122) is present so as to provide natural amplification for the notes produces by a player (not pictured). As with all stringed instruments, the double bass 100 of FIG. 1 includes strings 115 (in this case, four) strung between a head end 113 and a fixed tailpiece 127 with a bridge 125 in between to hold the strings away from a neck 112. The head end 113 may typically include a string nut 111 as well as a scroll 110. At the bottom of the conventional double-bass 100, a tail pin 128 is disposed to hold the instrument off the ground when playing.

The conventional double-bass 100 includes a wide and robust body that includes an upper body portion called an upper bout 122a and lower body section called a lower bout 122b that are separated by conventional c-bout 130a and 130b on either side of the strings. The strings are strung above a fingerboard and may be tuned individually by adjusting tuning keys at the head. The body may further include f-holes 135 for enhancing acoustic properties of the double bass.

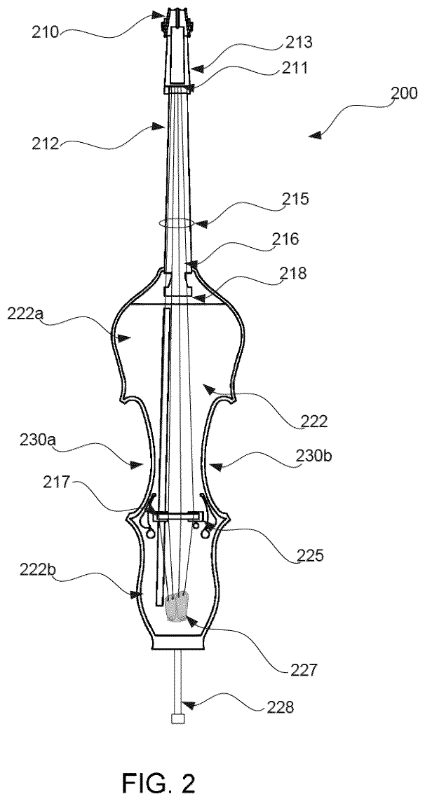

FIG. 2 is a plan view of a space efficient stand-up double bass instrument 200 according to an embodiment of the subject matter disclosed herein. In this novel double-bass instrument 200, one can see that the width and girth of the conventional double-bass has relatively “skinny” dimensions when compared to its height. Thus, a large and robust resonant chamber is no longer present in the body 222 because electronic amplification is utilized to produce notes by a player (not pictured). As with all stringed instruments, the double bass 200 of FIG. 2 includes strings 215 (in this case, four) strung between a head end 213 and tail end 227 with a bridge 225 in between to hold the strings away from a neck 212. The head end 213 may typically include a string nut 211 as well as a scroll 210.

The novel double-bass 200 of FIG. 2 includes a narrow, yet still robust body 222 that includes an upper body portion called an upper bout 222a and lower body section called a lower bout 222b that are separated by novel, more-narrowly configured c-bout 230a and 230b on either side of the strings 215. The strings 215 are strung above a fingerboard 216 and may be tuned individually by adjusting tuning keys (not shown in detail here) at the head end 213.

In this embodiment, a bass instrument 200 includes characteristics of a double bass from centuries past, but also includes features like portability, feedback control, and sustain. The bass instrument 200 weighs 14.5 lbs. and has a 41″ scale length in one embodiment. The bass instrument 200 may include electric pickups 217 disposed adjacent to respective strings 215 near the bridge 225 such as RMC pizz-arco sensors for each string that feed to an RMC Polydrive II preamp. The bass instrument 200 has both ¼″ mono out as well as a 13-pin polyphonic output, which may be fed to a MIDI instrument such as a Roland VG MIDI unit. The electric pickups 217 also are adept at detecting both pizzicato to arco playing styles.

In one embodiment, the bass instrument 200 includes a carved spruce head end 213. The body may comprises sides and back that may be solid maple. Further, the neck 212 may also be solid maple. In other embodiments, additional options include more economical choices such as a fir head end 213 as well as sycamore sides and back of the body 222 and neck 212. The fingerboard 216 may be ebony, although other options may be more aligned with using ArcoTech™, which may be a carbon fiber alternative to ebony and a more sustainable as well as durable option. The bass instrument 200 is designed additional features that include a bass bar, sound post, carved top & back, and the like, but in a compact form as depicted in FIG. 2.

As alluded to, the compact sized space efficient design of this stand-up double bass 200 includes a narrow profile when viewed on a horizontal axis. As can be seen, the c-Bout sections 222a and 222b of a typical double bass are still present but with reduced width and girth. Thus, with the narrow horizontal axis, electronic feedback may be greatly reduced when utilizing the electronic pickups 217 via an amplifier or any type of effects pedal. That is, the wider a stringed instrument is across the horizontal X-axis, the more feedback it will produce when amplified (via electronic pickups or external microphone). The more extended that a stringed instrument is along the vertical Y-axis, the more sustain it will have. In focusing on the X- and Y-axes, it is the X-axis where the bass instrument 200 truly differentiates from other acoustic double bass instruments. It is in the horizontal alignment with the bridge 225 where sub-octave notes resonate and reproduce, causing amplified feedback through an electronic transducer such as a pickup system or microphone. The X-axis dimension of the bass instrument 200 is designed to be narrow so as to limit amplified feedback without affecting tone or sustain.

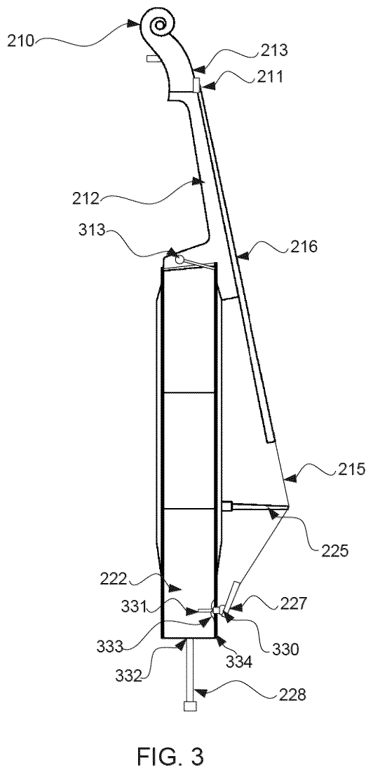

In another feature of the bass instrument 200, the floating tailpiece 227 is designed to support the full 300+ lbs. of string tension by means of two socket head ball studs that are threaded into the bottom block near the base of the instrument on either side of the endpin bore. Instead of the typical cable that extends from the tailpiece to loop around the endpin, the cables are embedded within the tailpiece assembly and secure themselves to the ball studs. The entire mechanism is obscured from view in FIG. 2, so the relevant portions of this feature can also be seen and described below in FIG. 3. At the bottom of the bass instrument 200, a tail pin 228 is disposed to hold the instrument off the ground when playing.

The bass instrument 200 may include a removable and adjustable neck 212 that can be rotatable hinged to the body 222 such that it may be rotated to a stored position thereby reducing the overall instrument length when travelling. The adjustable neck 212 incorporates an I-beam for added strength through the arc as well as a means of easily adjusting the string height (action) at full tension and without having to retune the bass instrument 200 following adjustment. The hinged attachment means 218 also accommodates the unique ability to different necks 212 (e.g., a four-string neck or a five-string neck) with the same body 222. For example, a player will have the option to use both a 4-string neck and a 5-string neck with the same bass instrument 200. Specific travel cases are able to house both of these neck configurations along with the bass body to make for a lightweight, versatile and interchangeable system.

In another novel feature, the bass instrument 200 may include a removable fingerboard 216. With a length of nearly 34 inches, the fingerboard 216 is the longest measured individual component of the bass instrument 200. The fingerboard 216 adds 17 inches to the length of the neck 212 and head end 213 when attached. By adding the option to remove the fingerboard 216 during transport, the ability to house all parts of the bass instrument 200 in a much shorter travel case is achieved. The fingerboard 216 can be attached by either using a series of rare earth magnets or by installing several nested frame connectors.

In another novel feature, the bass instrument 200 may include an adjustable, removable, and interchangeable string nut 211. This unique string nut 211 is designed to be raised or lowered by turning two Allen bolts located adjacent to the string nut 211. This unique string nut 211 has over 10 times the mass of a conventional string nut and rests upon the top of the neck 212 at the base of the head end 213. The string nut 211 may comprise both 4-string and 5-string configurations so as to accommodate two different set s of strings while using the same neck 212 and fingerboard 216. It also acts to secure the removable fingerboard 216 while assembled and rests between the two cheeks of the head end 213.

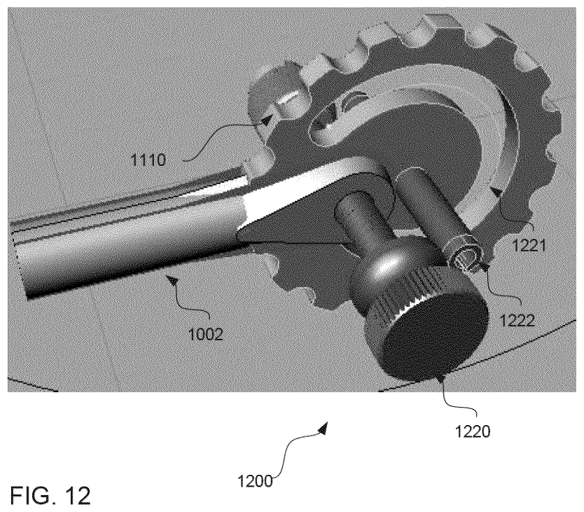

FIG. 3 is a profile view of the bass instrument 200 of FIG. 2 according to an embodiment of the subject matter disclosed herein. The neck adjustment means 313 shown here lets an end user adjust the angle of the neck 212 while the bass instrument 200 is tuned up. Thus, because of this neck joint adjustment means 313, one can change the action of the bass instrument 200 without the need to re-tune. The neck adjustment means 313 acts like a hinge, and pivots around a point located approximately 2 mm above the 12th fret of the fingerboard 216. Since the pivot is essentially on the strings 215, the strings 215 don't stretch or go slack as the action is adjusted. There are several different adjustment mechanisms contemplated, and the thumbwheel design as shown is this embodiment is shown in further detail with respect to FIG. 12 below.

As alluded to with respect to FIG. 2, in another feature of the bass instrument 200, a floating tailpiece 227 is designed to support the full 300+ lbs. of string tension by means of two socket head ball studs 330 that are threaded 331 into the bottom block near the base of the instrument on either side of the endpin bore 332. Instead of a conventional exterior cable (not show) that extends from the tailpiece 227 to loop around the endpin 228, this embodiment features interior cables 333 are embedded within the tailpiece assembly 334 and secure themselves to the ball studs 330.

The stand-up bass instrument 200 of FIG. 3 may further comprise a removable fingerboard 216 that is removably coupled to the neck 212 and configured to be secured to and unsecured from the neck 212. This is yet another way in which the compact stand-up double bass instrument 200 may be stored in a compact manner.

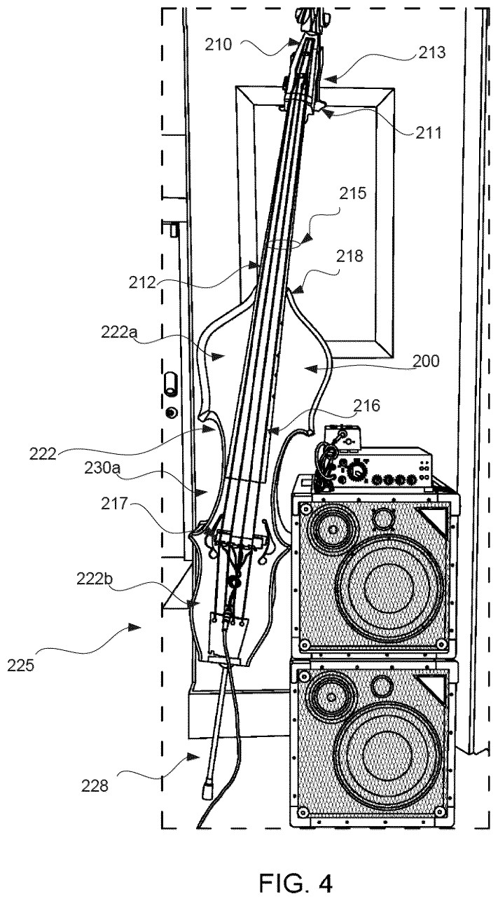

FIG. 4 is an isometric view of a space efficient stand-up double bass instrument 200 according to an embodiment of the subject matter disclosed herein. The particular body shape (e.g., wide shoulders, narrow waist) is a signature aspect of the design and is unique to the space efficient stand-up double bass 200 shown in FIG. 4. The shoulders (e.g., upper c-bouts 222a) act as a familiar reference when playing the bass instrument 200 as well as an armrest when playing in the thumb position. The sound holes comprise an additional signature aspect of the design of the bass instrument 200 and are unique to the design of the space efficient stand-up double bass instrument 200. The Pleurant Tulipe scroll 210 is a signature aspect of the design and is unique to space efficient stand-up double bass instrument 200. Further, the overall design provides for a space efficient stand-up double bass instrument 200 that weighs less than 50 pounds.

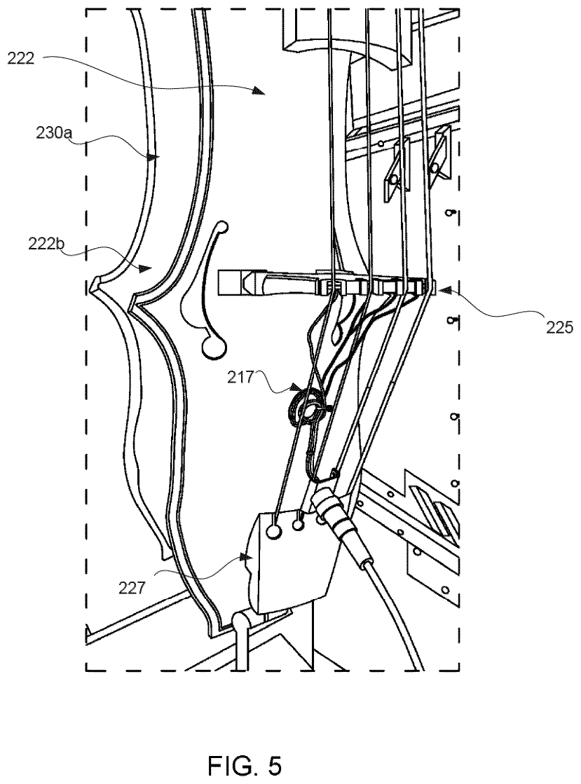

FIG. 5 is an isometric view of a bridge 225 of the space efficient stand-up double bass instrument 200 of FIG. 2 according to an embodiment of the subject matter disclosed herein. In one embodiment, the bridge includes a three-piece adjustable bridge 225 configured to limit consistent transference of vibration from the strings 215 to the body 222. In another embodiment, the bridge 225 may comprise seven pieces that include two adjustment wheels, two threaded posts, two bridge feet and then the actual bridge. These individual components are not show in detail in FIG. 5 but depicted in FIG. 9 and described below in more detail. In yet another embodiment, the bridge 225 may comprise a single piece (e.g., monolithic) of wood that is more effective at producing the best tone and volume for the strings and the bass instrument 200. As such, any dynamic adjustment to string height on a bass instrument 200 after it has been set up may be performed elsewhere with a fixed bridge 225, such as with the adjustable neck and the adjustable string nut.

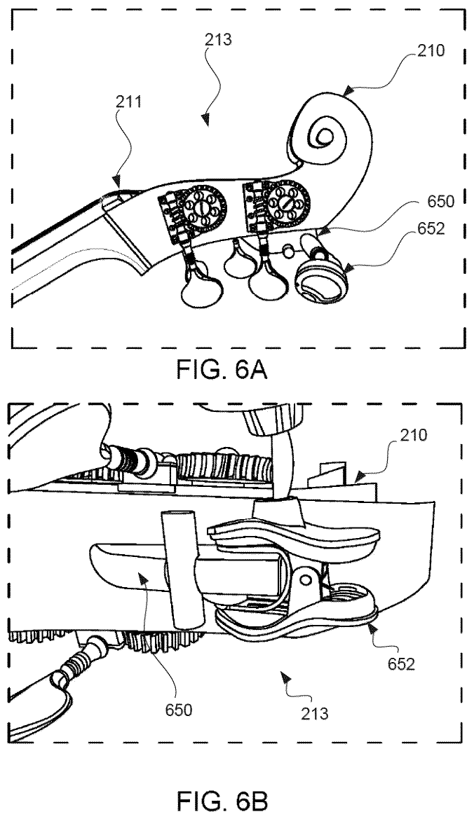

FIGS. 6A/B are views of a scroll 210 of the space efficient stand-up double bass instrument 200 of FIG. 2 according to an embodiment of the subject matter disclosed herein. The overall mass of the head end 213 and scroll 210 can be integral to sustaining notes along the Y-axis as this is where string vibration is most concentrated. The bass instrument 200 is specifically designed to retain up to 80% of the mass of a normal three-quarter-size acoustic bass head end 213 as well as accommodating the unique means of attaching a clip-on tuner 652 to an otherwise inaccessible area at the end of the scroll 210 by way of installing a channel 650 along the back of the scroll 210. Clip-on tuners are most effective at reading notes accurately when attached to the furthest point of the scroll 210 from the string nut 211.

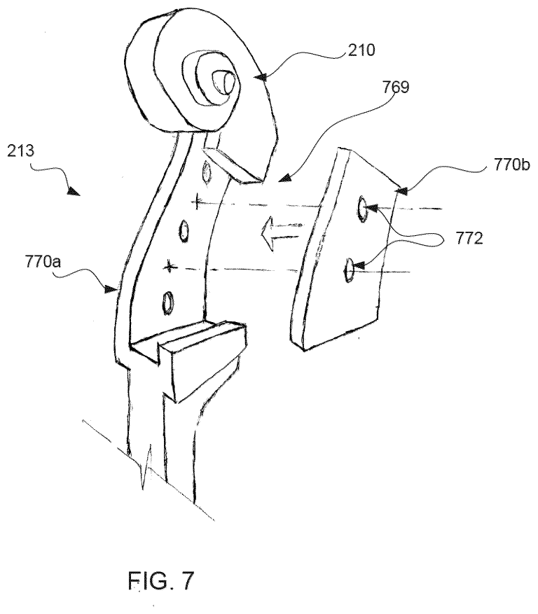

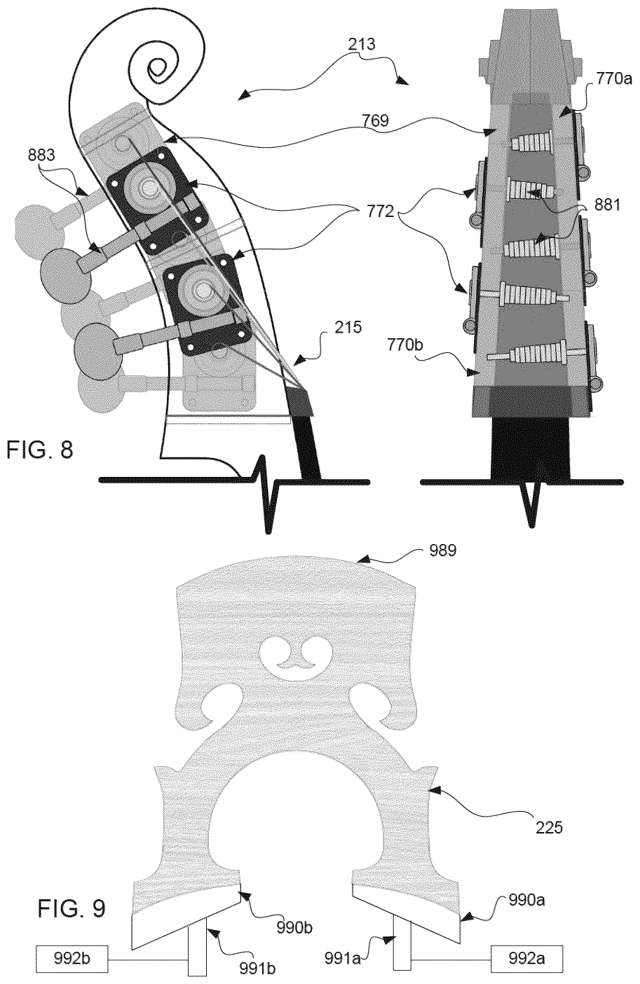

FIG. 7 is an isometric view of a head end 213 having a removable peg box 769 of the space efficient stand-up double bass 200 instrument of FIG. 4 having portions that may be disassembled of the space efficient stand-up double bass instrument of FIG. 4 according to an embodiment of the subject matter disclosed herein. As shown in this embodiment, the head end 213 includes features enabling removable portions of a peg box 769 such that the entire peg box 769 may be disassembled for storage and transport. Thus, a first removable portion 772a (e.g., a “cheek”) of the peg box 769 is shown FIG. 7 as being removed from the rest of the head end 213 and the scroll 210. Likewise, the other side also include a second removable portion 770b (e.g., other cheek) though is FIG. 7, it is depicted as remaining engaged with the rest of the head end 213 and the scroll 210. In this manner, the head end 213 may be dissembled and removed for maintenance and transport. Further, each removable portion includes one or more orifices 772 to facilitate tuning keys (e.g., “pegs”-shown in FIG. 8) for receiving one end of a tunable string.

FIG. 8 includes two plan views of the removable peg box 769 of FIG. 7 of the space efficient stand-up double bass instrument 200 of FIG. 2 according to an embodiment of the subject matter disclosed herein. The removable peg box 769, as discussed above, is another feature of the space efficient stand-up double bass instrument 200 that leads to compact storage, transportability, and ease of use. The removable peg box 769 is also shown here as having a left portion 770a (sometimes called a “cheek”) and a right portion 770b that may be removably secured with the head end 213. Both the left portion 770a and the right portion 770b may include orifices 772 for string anchoring 881 and tuning apparatuses 883. In this manner, a cavity between the left portion 770a and the right portion 770b is formed such that the strings 215 may engage the string anchors 881 between the portions and be semi-enclosed for maintaining tuning, once tuned.

FIG. 9 is a plan view of a removable and adjustable bridge 225 of the space efficient stand-up double bass 200 instrument of FIG. 2 removed from the instrument according to an embodiment of the subject matter disclosed herein. In this embodiment, the bridge 225 may comprise seven pieces that include two adjustment mechanisms 992a and 992b, two threaded posts 991a and 991b, two bridge feet 990a and 990b and then the actual bridge facing 989. As the adjustment mechanisms are actuated, the bridge feet 990a and 990b may be raised or lowered thereby adjusting the action on the strings supported by the bridge facing 989.

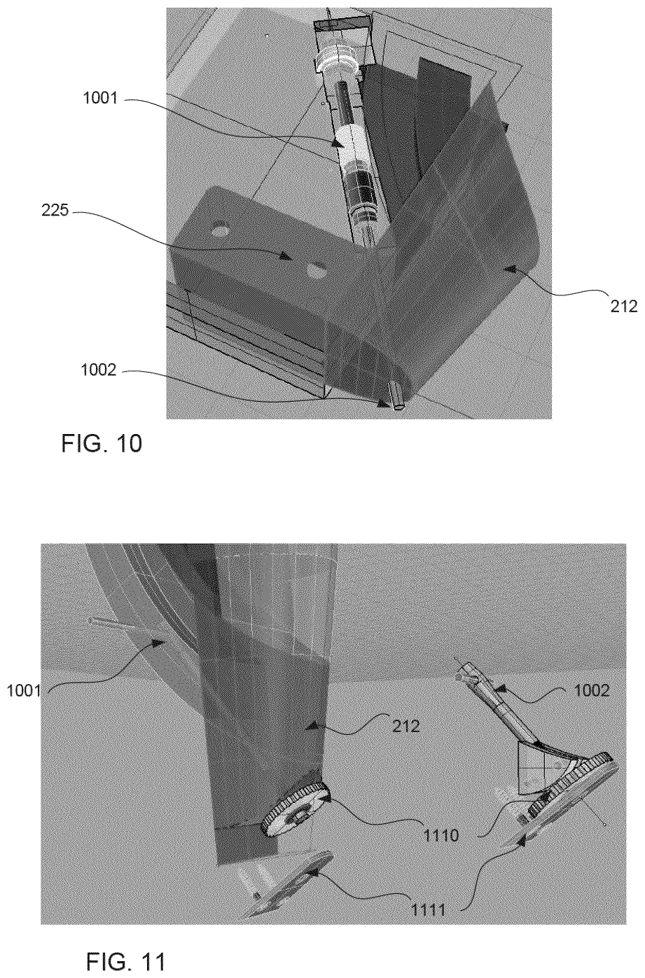

FIG. 10 is a plan view of an internal biasing means 1001 for a neck adjustment mechanism 313 of the space efficient stand-up double bass instrument 200 of FIG. 2 according to an embodiment of the subject matter disclosed herein. As discussed above, the neck 216 of the stand-up double bass instrument 200 of FIG. 2 may be adjusted after setup with an adjustment mechanism 313 such that the neck 216 may be biased in one direction (e.g., forward) by actuating the internal biasing means 1001 in one way that is responsive to an actuation shaft 1002 (e.g., the shaft is rotating one way). Likewise, the neck 216 may be biased in another opposite direction (e.g., backward) by actuating the internal biasing means 1001 in a second way that is responsive to the actuation shaft 1002 (e.g., the shaft is rotating the other way). In this manner, a musician may adjust the action from the pivot point near the adjustment mechanism 313 without affecting the turning of the instrument.

FIG. 11 is an isometric view of an external actuation means 1110 for a neck adjustment mechanism 313 of the space efficient stand-up double bass instrument 200 of FIG. 2 according to an embodiment of the subject matter disclosed herein. As seen in FIG. 11, the actuation shaft 1002 is coupled to an actuation thumbwheel 1110 such that the actuation shaft 1002 may be turned in one rotational direction or an opposite rotational direction. Such an actuation motion may translate to maneuvering the neck 216 forward or backward with respect to a plane corresponding to engaged strings 215. Further, the actuation thumbwheel 1110 may be secured to the actuation shaft 1002 by a securing plate 1111. This specific embodiment of an actuation thumbwheel 1110 may be realized for additional adjustment mechanisms in the stand-up double bass instrument 200 of FIG. 2 as discussed next with respect to FIG. 12.

FIG. 12 is an isometric view of an external actuation means 1200 for various adjustment points, such as a string nut adjustment mechanism or a bridge adjustment mechanism, of the space efficient stand-up double bass instrument 200 of FIG. 2 according to an embodiment of the subject matter disclosed herein. As shown here, the external actuation means 1200 includes an actuation thumbwheel 1110 coupled an actuation shaft 1002 that may provide biasing force to a device (e.g., the bridge 225, the string nut, or the neck 216) to realize action adjustments to the space efficient stand-up double bass instrument 200. The action adjustment may be adjusted by means of an actuation thumbwheel 1110 that includes a thumbwheel channel 1221 that is centered about a thumbwheel pin 1222 such that a bias force is imparted longitudinally to the actuation shaft 1002 through an Actuator pin 1220 that is secured within the thumbwheel channel 1221. In this manner forward or backward bias is imparted to an underlying instrument part such as the bridge 225, the string nut, or the neck 216.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having.” “including.” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

That which is claimed is:

1. A stand-up bass instrument, comprising:
a body having a narrow profile configured to anchor first ends of a set of strings at a tail end;
a neck having a first end and a second end such that the first end is removably secured to the body in a position adjacent to the set of strings; and
a head end coupled to the second end of the neck and configured to anchor second ends the set of strings;
wherein the neck is configured to be adjustable when secured to the body via an adjustment mechanism that alters a position of the neck when adjusted.

2. The stand-up bass instrument of claim 1, further comprising a floating tailpiece disposed at the tail end of the body wherein the floating tailpiece pivotably secured to the tail end by two ball studs threaded into the tail end and further secured by at least one anchor cable embedded within the body.

3. The stand-up bass instrument of claim 1, further comprising narrow profile comprises C-bouts with a width no greater than one fifth of a length of the body.

4. The stand-up bass instrument of claim 1, further comprising one or more electronic pickups disposed in the body adjacent to one or more respective strings in the set of strings.

5. The stand-up bass instrument of claim 1, wherein the head end further comprises:
an adjustable string nut having an adjustment mechanism to raise or lower a height of the string nut with respect to neck;
a scroll; and
a solid-body channel disposed contiguous with the scroll and configured to receive a clip-on tuner.

6. The stand-up bass instrument of claim 1, wherein the adjustment mechanism further comprising a thumbwheel actuator configured to shift an angle of the neck in a first direction when the thumbwheel actuator is rotated in a first manner and configured to shift the angle of the neck in a second direction that is opposite the first direction when the thumbwheel actuator is rotated in a second manner.

7. The stand-up bass instrument of claim 1, wherein the set of strings further comprises a set of four strings and the neck further comprises a size configured to fit a fingerboard configured for a set of four strings.

8. The stand-up bass instrument of claim 1, wherein the set of strings further comprises a set of five strings and the neck further comprises a size configured to fit a fingerboard configured for a set of five strings.

9. The stand-up bass instrument of claim 1, further comprising a removable fingerboard removably coupled to the neck and configured to be secured to and unsecured from the neck.

10. The stand-up bass instrument of claim 1, further comprising a removable and adjustable bridge disposed between the body and the set of strings; the bridge further comprises a monolithic wood bridge.

11. A stringed instrument, comprising:
a body having a narrow profile configured to anchor first ends of a set of strings at a tail end;
a neck having a first end and a second end such that the first end is removably secured to the body in a position adjacent to the set of strings; and
a head end coupled to the second end of the neck and configured to anchor second ends the set of strings;
wherein the neck is configured to be adjustable when secured to the body via an adjustment mechanism that alters a position of the neck when adjusted.

12. The stringed instrument of claim 11, further comprising a floating tailpiece disposed at the tail end of the body wherein the floating tailpiece pivotably secured to the tail end by two ball studs threaded into the tail end and further secured by at least one anchor cable embedded within the body.

13. The stringed instrument of claim 11, further comprising narrow profile comprises C-bouts with a width no greater than one fifth of a length of the body.

14. The stringed instrument of claim 11, further comprising one or more electronic pickups disposed in the body adjacent to one or more respective strings in the set of strings.

15. The stringed instrument of claim 11, wherein the head end further comprises:
an adjustable string nut having an adjustment mechanism to raise or lower a height of the string nut with respect to neck;
a scroll; and
a solid-body channel disposed contiguous with the scroll and configured to receive a clip-on tuner.

16. The stringed instrument of claim 11, wherein the adjustment mechanism further comprising a thumbwheel actuator configured to shift an angle of the neck in a first direction when the thumbwheel actuator is rotated in a first manner and configured to shift the angle of the neck in a second direction that is opposite the first direction when the thumbwheel actuator is rotated in a second manner.

17. The stringed instrument of claim 11, wherein the set of strings further comprises a set of four strings and the neck further comprises a size configured to fit a fingerboard configured for a set of four strings.

18. The stringed instrument of claim 11, wherein the set of strings further comprises a set of five strings and the neck further comprises a size configured to fit a fingerboard configured for a set of five strings.

19. The stringed instrument of claim 11, further comprising a removable fingerboard removably coupled to the neck and configured to be secured to and unsecured from the neck.

20. The stringed instrument of claim 11, further comprising a removable and adjustable bridge disposed between the body and the set of strings; the bridge further comprises a monolithic wood bridge.
